(19) United States
(12) Patent Application Publication
(10) Pub. No.: US 2016/0124582 A1
(43) Pub. Date: May 5, 2016

(54) TERMINAL APPARATUS AND METHOD FOR CONTROLLING THE SAME

(71) Applicant: Samsung Electronics Co., Ltd., Gyeonggi-do (KR)

(72) Inventors: Jung-joo SOHN, Seoul (KR); Yoon-su KIM, Seoul (KR); Sahng-hee BAHN, Gyeonggi-do (KR); Keum-koo LEE, Gyeonggi-do (KR); Hye-jin LEE, Gyeonggi-do (KR); Young-kyu JIN, Seoul (KR)

(73) Assignee: Samsung Electronics Co., Ltd.

(21) Appl. No.: 14/932,608

(22) Filed: Nov. 4, 2015

(30) Foreign Application Priority Data
Nov. 4, 2014 (KR) 10-2014-0152369

(51) Int. Cl. G06F 3/0481; G06F 3/0482; G06F 9/44; G06F 3/0484; G09G 5/14; G06F 3/14

(52) U.S. Cl. CPC G06F 3/0481; G06F 3/04817; G09G 5/14; G06F 3/1454; G06F 9/4443; G06F 3/04842; G06F 3/0482; G06F 2203/04803

(57) ABSTRACT

Methods, apparatuses, and systems for interlinking applications/apparatuses are described. In one method herein, a terminal apparatus displays a User Interface (UI) screen of an operable/running application from among the applications stored on the terminal apparatus. When metadata is input into the operable/running application corresponding to the displayed UI screen, an application which is interlinked with the operable/running application is provided with all or some of the metadata which was input into the operable/running application.

### PRIORITY

This application claims priority under 35 U.S.C. §119 to Korean Patent Application No. 10-2014-0152369, which was filed on Nov. 4, 2014, in the Korean Intellectual Property Office, the contents of which are incorporated herein by reference.

### BACKGROUND OF THE INVENTION

1. Field of the Invention

The present disclosure relates generally to a terminal apparatus and a method for controlling the same and, more particularly, to a terminal apparatus in which a plurality of installed applications are interlinked and operate with each other, and a method for controlling the same.

2. Description of the Related Art

A terminal apparatus refers to an apparatus which can connect to, and receive various content from, the Internet or other networks through a communication network. A diverse variety of applications may be installed in a terminal apparatus, such as a smart phone, and thus, a user is able to find, install, and use various applications.

However, some applications installed in terminal apparatuses do not operate with each other. Accordingly, it is difficult to share and/or use information and/or content which is reproduced or executed in one application with and/or in other application.

For example, when a user listening to a song using a music reproduction application wishes to watch a music video of the song, the user needs to check information on the song (for example, a title or a singer of the song), operate a separate application for watching music videos, and search for the music video based on the information on the song retrieved from the music reproduction application. As shown in this example, the user may have to take several steps to obtain desired information directly relevant to content being currently reproduced and/or accessed.

When the user does not have or cannot obtain information on content currently being reproduced in an application, the aforementioned search process becomes even more difficult.

### SUMMARY OF THE INVENTION

The present disclosure addresses at least the issues discussed above and provides at least the advantages described below. According to one aspect of the present disclosure, a method and terminal apparatus are provided in which a plurality of installed applications can be interlinked and operate with each other.

According to an aspect of the present disclosure, a terminal apparatus is provided which includes storage capable of storing a plurality of applications, some of which may be interlinked; a display capable of displaying a User Interface (UI) screen of a first application among the plurality of stored applications; and a controller which, when metadata is input into the first application corresponding to the displayed UI screen, provides a second application which is interlinked with the first application with at least some of the metadata input into the first application.

According to another aspect of the present disclosure, a terminal apparatus is provided which includes storage capable of storing a plurality of applications; a display capable of displaying User Interface (UI) objects, each of which corresponds to one of the plurality of stored applications; and a controller which, in response to at least one first displayed UI object being placed on a second displayed UI object, interlinks the two applications corresponding to the first and second UI objects.

According to another aspect of the present disclosure, a method for controlling a terminal apparatus is provided, which includes displaying a User Interface (UI) screen of a first application from among a plurality of applications stored on the terminal apparatus; and, when metadata is input into the first application corresponding to the displayed UI screen, providing a second application which is interlinked with the first application with at least some of the metadata inputted into the first application.

According to another aspect of the present disclosure, a method for controlling a terminal apparatus is provided, which includes displaying User Interface (UI) objects. each of which corresponds to one of a plurality of applications stored on the terminal apparatus; and, when a control command to place at least one first displayed UI object on a second displayed UI object is received, interlinking the two applications corresponding to the first and second UI objects.

According to another aspect of the present disclosure, a computer readable medium having a program for executing a method for controlling a terminal apparatus is provided. The method includes displaying a User Interface (UI) screen of a first application from among a plurality of applications stored on the terminal apparatus; and, when metadata is input into the first application corresponding to the displayed UI screen, providing a second application which is interlinked with the first application with at least some of the metadata inputted into the first application.

### BRIEF DESCRIPTION OF THE DRAWINGS

The above and other features, advantages, and/or aspects will become apparent and more readily appreciated from the following detailed description, when taken in conjunction with the accompanying drawings, in which:

FIG. 1 is a block diagram illustrating a structure of a terminal apparatus according to an embodiment of the present disclosure;

FIG. 2 is a block diagram illustrating a configuration of software according to an embodiment of the present disclosure;

FIGS. 3A and 3B are views illustrating interlinking operations of a plurality of applications according to embodiments of the present disclosure;

FIG. 4 is a view illustrating an interlinking operation between two applications according to an embodiment of the present disclosure;

FIG. 5 is a visual representation of four types of interlinking operations which may be performed according to embodiments of the present disclosure;

FIGS. 6 to 10 are views of screen displays showing various examples of interlinking operations according to embodiments of the present disclosure;

FIGS. 11A to 11C are views of consecutive screen displays when performing a method for setting interlinking according to a first embodiment of the present disclosure;

FIG. 12 is an example of a User Interface (UI) window displayed on a TV, i.e., other terminal apparatus, which is interlinked with the second application (execution window 1152 in FIG. 11C), according to an embodiment of the present disclosure;

FIGS. 13A to 13D are views of consecutive screen displays when performing a method for setting interlinking according to a second embodiment of the present disclosure;

FIGS. 14A to 14D are views of consecutive screen displays when performing a method for setting interlinking according to a third embodiment of the present disclosure;

FIGS. 15A and 15B are views of screen displays when performing a method for setting interlinking according to a fourth embodiment of the present disclosure;

FIGS. 16A and 16B are also views of screen displays when performing a method for setting interlinking according to the fourth embodiment of the present disclosure;

FIGS. 17A and 17B are visual representations of a preview operation according to an embodiment of the present disclosure; and

FIG. 18 is a flowchart of a method for controlling a terminal apparatus according to an embodiment of the present disclosure.

### DETAILED DESCRIPTION OF EMBODIMENTS

Embodiments of the present disclosure are described in detail below with reference to the accompanying drawings. Same or similar components may be designated by the same or similar reference numerals although they are illustrated in different drawings. Detailed descriptions of constructions or processes known in the art may be omitted to avoid obscuring the subject matter of the present invention and/or as already known to persons of ordinary skill in the art.

The terms “first”, “second”, . . . may be used herein to label/designate various components, parts, steps, etc., but these terms are only used to distinguish one component, part, step, etc. from the other components, parts, steps, etc.

The terms used in the present disclosure are only used for purposes of description/illustration, and are not intended to limit the scope of the present disclosure. The singular expression also includes the plural meaning unless the context indicates otherwise. In the present application, a “module” or a “unit” may perform at least one function or operation, and may be implemented in hardware, software, or a combination of hardware and software.

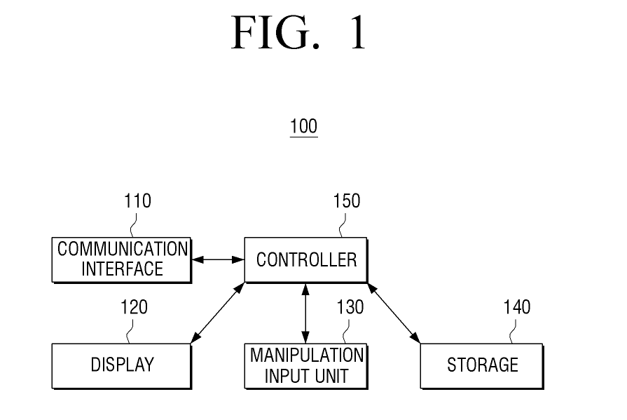

FIG. 1 is a block diagram illustrating a structure of a terminal apparatus according to an embodiment of the present disclosure.

In FIG. 1, a terminal apparatus 100 according to an embodiment of the present disclosure includes a communication interface 110, a display 120, a manipulation input unit 130, a storage 140, and a controller 150. The terminal apparatus 100 may be a smart phone, a laptop computer, a Portable Multimedia Player (PMP), an MP3 Player, a smart TV, a wearable device (for example, a smart watch), etc.

The communication interface 110 connects the terminal apparatus 100 to an external apparatus (such as, to be more specific, other terminal apparatuses and/or the Internet or other network). The communication interface 110 may connect to an external apparatus by a Local Area Network (LAN), the Internet, and/or a wireless communication method, such as, for example, Z-wave, 4LoWPAN (IEEE 802.15.4 Low power Personal Area Network), Radio Frequency Identification (RFID), Long Term Evolution (LTE) Device-to-Device (D2D) communication, Bluetooth Low Energy (BLE), General Packet Radio Service (GPRS), Weightless, Edge Zigbee, the ANT+ protocol from the ANT+ Alliance, Near Field Communication (NFC), Infrared Data Association (IrDA), Digital European Cordless Telephone (DECT), Wireless Local Area Network (WLAN), Bluetooth, Wireless Fidelity (Wi-Fi), Wi-Fi Direct, General System/Standard for Mobile Communication (GSM), Universal Mobile Telephone System (UMTS), LTE, Wireless Broadband Internet (WiBro), etc.

The communication interface 110 may transmit/receive various data to/from other terminal apparatuses. To be more specific, the communication interface 110 may receive metadata and/or content from other terminal apparatuses. For example, when an application which is currently operating on terminal apparatus 100 is interlinked and operates with other terminal apparatuses, the communication interface 110 may receive metadata and content which are used to operate the application from the other terminal apparatuses.

Herein, the other terminal apparatus may be any apparatus which is capable of performing the functions as described herein. Terminal apparatus 100 according to an embodiment of the present disclosure or the other terminal apparatuses with which it connects may be, for example, a smart phone, a laptop computer, a desktop Personal Computer (PC), a Personal Digital Assistant (PDA), an electronic book (E-book) reader, a terminal for digital broadcasting, a kiosk, an electronic picture frame, navigation, a digital TV, a wearable device (such as, for example, a wrist watch or Head-Mounted Display (HMD)), and other mobile/non-mobile computing devices.

Metadata as used herein may be an attribute relevant to content (for example, a song title or a signer of a music content, photographing time information or photographing location information of a picture content, etc.), user account information, location information, Uniform Resource Locator (URL) address, or a control command with respect to other terminal apparatuses. The metadata may include one or more pieces of information as described above or the like.

The communication interface 110 may transmit a control command and/or a content to other terminal apparatuses. For example, when an application currently operating on terminal apparatus 100 is interlinked and operates with other terminal apparatuses, the communication interface 110 may transmit a control command and/or a content generated in the currently operated application to one or more of the other terminal apparatuses.

The display 120 may display whatever terminal apparatus 100 supports. The display 120 may be a monitor, such as, a Liquid Crystal Display (LCD), a Cathode-Ray Tube (CRT), etc. In addition, the display 120 may be realized as a touch screen which also performs the function of the manipulation input unit 130 described below.

A list of applications installed in the terminal apparatus 100 may be displayed on display 120. For example, the display 120 may display the applications as icons, widgets or tiles, perhaps including only a part of its name/title, or as an execution window that is inside or forms an operation screen of the application. Hereinafter, any graphic object representing and/or relevant to an application, such as, for example, the aforementioned icons, widgets, tiles, execution windows, etc., are referred to as “User Interface (UI) object”.

With respect to currently operating interlinked applications, the display 120 may display an indicator/icon/symbol/sign notifying the user that the applications are interlinked. Such an indication or sign may be displayed in various positions, such as, between icons of interlinked applications/objects, between a widget and an icon, between a widget window and a widget window, between an execution window and an icon, between an execution window and an execution window, between a widget window and an execution window, etc. The indication or sign itself may be a particular icon or may be an edge, layout, frame, and/or other indication showing two widgets or execution windows in a lump or otherwise together. For example, when a currently operating application is interlinked with another application being operated on another terminal apparatus, the display 120 may display their execution windows interlinked. In response to icons (or widgets) having the interlink sign being selected by a user, the display 120 may display execution windows corresponding to the icons simultaneously. In this case, the display 120 may display a different indicator/icon/symbol/sign which indicates that the two execution windows are interlinked, such as by, for example, using one edge.

Other applications interlinked with a currently operating and/or selected application may be displayed. For example, in response to a user selection of a particular application or an event occurring in a currently operated application (for example, the application being connected to another terminal apparatus), the display 120 may display other applications which are interlinked with the currently operated application. The user may easily set other applications to be interlinked with the currently displayed application. Depending on the implementation, the applications may be interlinked by selection of a user, selection by the terminal apparatus or other device, etc., or may be directly interlinked automatically without any input from a user.

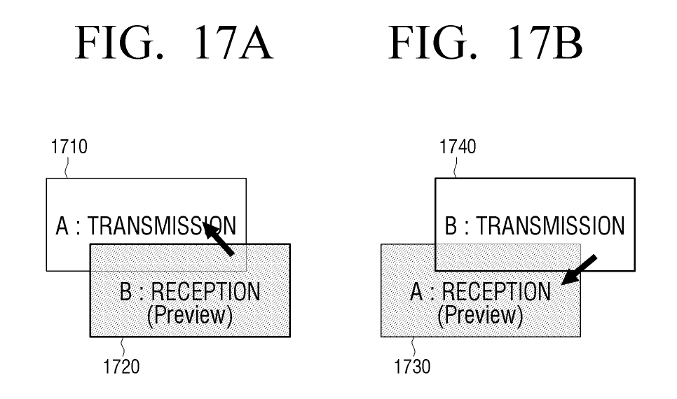

Depending on the implementation, the user may set the applications to be interlinked manually. As a more specific example, the display 120 may display a UI object for each of a plurality of applications which are installed in terminal apparatus 100. In response to a touch gesture or a control command, such as superimposing one UI object on another UI object on the screen, made by a user through the manipulation input unit 130, the display 130 may interlink the two applications corresponding to the two superimposed UI objects. In response to two UI objects being superimposed (before a touch event for placing the objects, such as a release), the display 120 may display a preview of the two applications corresponding to the two UI objects interlinked. One example of displaying a preview of a UI object is described below with reference to FIG. 17.

When the applications corresponding to the two UI objects cannot be interlinked, the display 120 may display information notifying the user of the situation instead of the preview screen.

In response to the second application interlinked with the first application being an application which may provide a particular content, the display 120 may display an execution result of the first application as a first screen and display an execution result of the second application (that is, an execution result of the second application with respect to metadata input into the first application) simultaneously.

When the second application has a sub UI screen, the display 120 may display the sub UI screen of the second application while displaying the first screen of the first application. The sub UI screen is a screen which is distinct from the main UI screen displayed when the second application is executed solely. In such a case, the sub UI screen is displayed only when the second application is dependent on the first application.

For example, a TV reproduction application which receives a screen displayed in an other terminal apparatus in a streaming manner may display the screen received in a streaming manner when the TV reproduction application operates solely. When the TV reproduction application is being interlinked with a video reproduction application of an other terminal apparatus, the display 120 may display the sub UI screen of the video reproduction application, which is used for receiving user control commands of the video being reproduced, instead of the main UI screen, which displays the streaming video itself.

When a remote control application which controls an operation of a camera of a smart watch is being operated alone, a manipulation UI object for controlling a camera operation of the smart watch, may be displayed. However, when the remote control application is being interlinked with a server storage application which stores data in a cloud server, the remote control application may transmit picture contents stored in the smart watch to the cloud server. In this case, while the remote control application is being interlinked with the server storage application, the display 120 may display a UI object for receiving a selection of the pictures stored in the smart watch, instead of the manipulation UI object for controlling the camera operation.

Depending on the embodiment, an interlinked application may display one or more UI screens/objects and/or perform one or more functions. When an application having a plurality of sub UIs is being interlinked, the display 120 may display a screen for the user to select a function/sub UI to be interlinked.

For example, a TV application may provide a streaming reproducing function of receiving and displaying a content reproduced in a TV in a streaming manner, a streaming providing function of transmitting a content stored in a terminal apparatus to a TV to be streaming reproduced, a server function of receiving and storing a content from outside, a remote controller function of controlling basic functions of a TV, etc. In response to the TV application being interlinked with the remote control application, the TV application may perform both the streaming providing function and the server function among the above described functions. In this case, in response to receiving a selection of a function to be interlinked, the display 120 may display a sub UI corresponding to the selected function. Meanwhile, in implementation, the display 120 may display all of the sub UIs corresponding to both the functions.

The manipulation input unit 130 may include a plurality of functions keys which enable a user to set or select various functions that the terminal apparatus 100 supports. The manipulation input unit 130 may be realized as, for example, a mouse, a keyboard, a touch screen which may perform both display and input, etc. The manipulation input unit 130 may receive an operating command with respect to any one of the installed applications, or with respect to a plurality of installed applications. For example, in response to one or more icons of interlinked applications being selected by a user, the interlinked applications may operate simultaneously.

The manipulation input unit 130 may receive a control command with respect to a currently operating application from a user. When metadata is changed by the control command, the changed metadata may be provided to other applications interlinked with the currently operating application.

The manipulation input unit 130 may receive an interlinking command with respect to the installed applications. For example, the manipulation input unit 130 may receive a touch gesture for placing a first UI object corresponding to the first application on a second UI object corresponding to the second application. Alternatively, the manipulation input unit 130 may receive an interlinking command through the user selecting an icon located on one side of the first UI object of the first application.

The storage 140 may store various programs and data necessary for the operations of the terminal apparatus 100. The storage 140 may be realized as a non-volatile memory, a volatile memory, a flash memory, a Hard Disk Drive (HDD), a Solid State Drive (SSD), etc. The storage 140 may be accessed by the controller 150, and the data in the storage 140 may be read/recorded/modified/updated by the controller 150. In the present disclosure, the term ‘storage’ includes, but is not limited to, a Read-Only Memory (ROM) or a Random Access Memory (RAM) in the controller 150, or a memory card mounted in or on the terminal apparatus 100 (for example, a micro Secure Digital (SD) card or a memory stick).

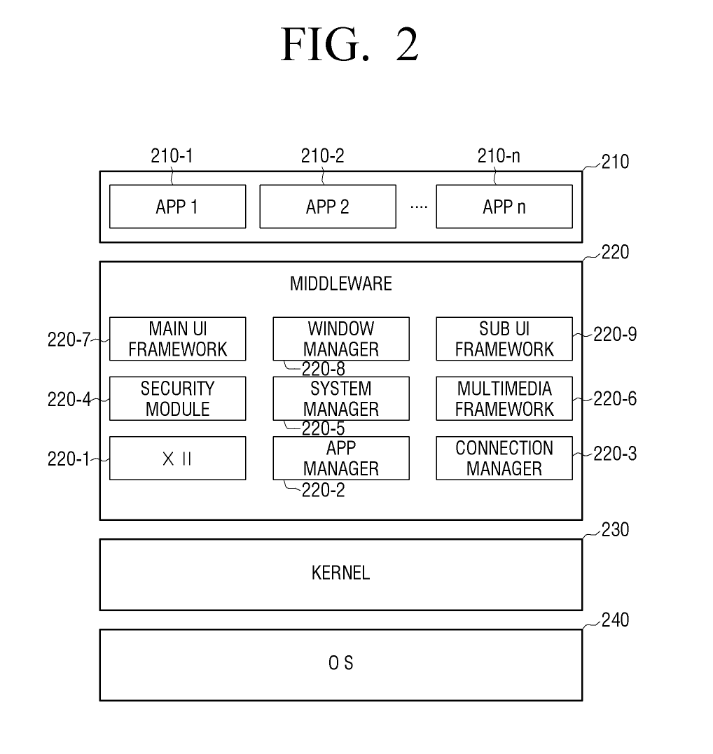

Storage 140 may store programs and data for configuring various screens to be displayed in the display 120. For example, the storage 140 may store a program of a set of diverse commands necessary for operating the terminal apparatus 100. Herein, “program” includes, but is not limited to, an application (or an application program) for providing a certain service and/or an operating program for operating the application. The detailed description of the configuration of a program stored in the storage 140 according to an embodiment of the present disclosure is provided below with reference to FIG. 2. The storage 140 may store content or metadata received through the communication interface 110.

The controller 150 controls components of the terminal apparatus 100. For example, the controller 150 uses various programs stored in the storage 140 to control overall operations of the terminal apparatus 100. The controller 150 may include a Central Processing Unit (CPU), a RAM, a ROM, and a system bus. In one embodiment, the ROM stores a set of commands for system booting. The CPU copies an Operating System (OS) stored in the storage 140 into the RAM according to a command stored in the ROM, and boots up the system by executing the OS. Upon completion of the boot-up operation, the CPU copies various applications stored in the storage 140 into the RAM and executes the applications copied into the RAM to perform various operations. Depending on the implementation, the controller 150 may include a plurality of CPUs, one or more Digital Signal Processor (DSP), and/or may comprise a System on Chip (SoC), etc.

In response to the terminal apparatus 100 being booted up, the controller 150 may control the display 120 to display UI objects corresponding to various applications installed in the terminal apparatus 100. For example, the controller 150 may control the display 120 to display icons corresponding to the applications in order to receive an operating command or a certain application. All or some of the applications may be displayed in the form of a widget or tile. In addition, with respect to interlinked applications, the controller 150 may control the display 120 to display an indicator/icon/symbol/sign indicating that the applications are interlinked.

The controller 150 operates the application selected by the user. When the application selected by the user is not interlinked with an other application, the controller 150 may control the display 120 to display only an execution window of the selected application. When the application selected by the user is an application which is interlinked and operates with an other terminal apparatus, the controller 150 may control the communication interface 110 to transmit/receive content or control commands according to a corresponding function of the interlinked other terminal apparatus.

When an interlinking command with respect to an application which is operating is received, the controller 150 may search for other application which may be interlinked with the application which is currently operating. In some embodiments, the controller 150 may search for applications which may use metadata similar to metadata which is used in the application which is currently operating. For example, in response to the application which is currently operating being capable of outputting location information, such as, a Global Positioning System (GPS) address, as metadata, the controller 150 may search for an application which may use location information, such as a map application, as an application which may be interlinked. The controller 150 may link a found application with the application which is currently operating.

In addition, thus far, it has been described that an interlinking command is received from a user after one application is selected, but in implementation, a selecting command and an interlinking command with respect to an application may be inputted simultaneously. For example, in response to at least one first UI object being placed on a second UI object, the controller 150 may interlink two applications corresponding to the first UI object and the second UI object. In this case, before the first UI object is superimposed on the second UI object and placed on the second UI object, the controller 150 may display, in the first object and/or the second object, a preview screen of a case in which the applications corresponding to the UI objects are interlinked.

In response to metadata being inputted into any one of the interlinked applications, the controller 150 may provide the other interlinked applications with the inputted metadata. For example, the controller 150 may provide a second application which is interlinked with the first application with metadata which was inputted into the first application. In response to the metadata of the first application being changed according to a user control command, the controller 150 may also provide the second application with the changed metadata.

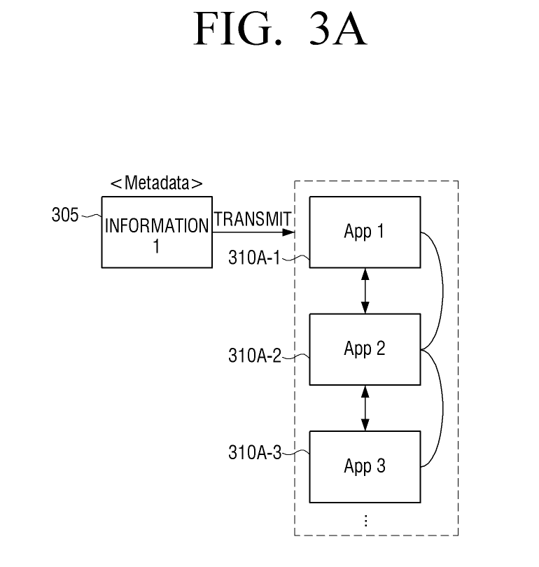

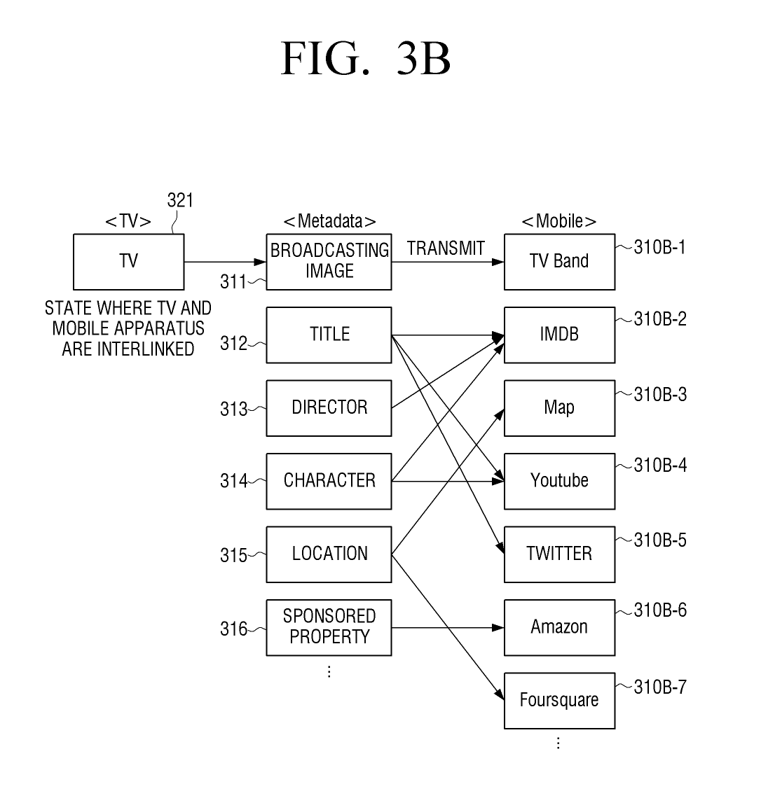

Depending on the implementation, the controller 150 may input, to the second application, the metadata inputted into the first application without change. Alternatively, the controller 150 may extract only metadata which may be used in the second application from among the metadata inputted into the first application and provide the second application with the extracted metadata. In addition, the controller 150 may provide only the metadata which may be used in the first application from among metadata provided from outside as the metadata inputted into the first application. Transmitting metadata will be discussed below with reference to FIGS. 3A and 3B.

In response to the interlinked applications being capable of sharing content, as well as metadata, the controller 150 may transmit a content inputted through the first application to the second application (which is interlinked with the first).

In FIG. 1, only the basic components directly relating to the present disclosure are illustrated and described, but, as would be understood by one of ordinary skill in the art, a terminal apparatus may have a variety of components performing a variety of functions. For example, the terminal apparatus may further include a photographing device, an audio processor, etc.

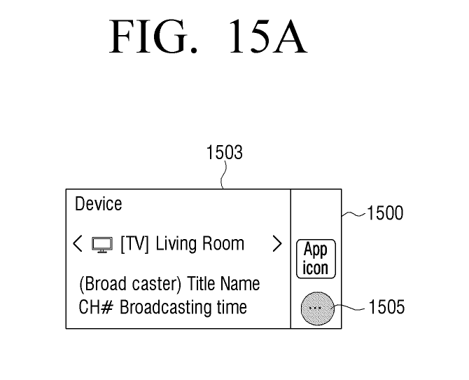

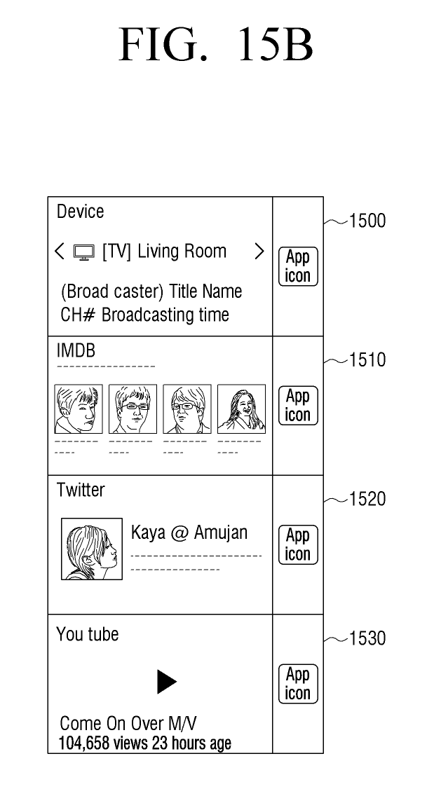

According to embodiments of the present disclosure, any number of applications may be interlinked. For example, as illustrated in FIG. 15B, four applications may be interlinked with each other. In addition, according to embodiments of the present disclosure, an application installed in a terminal apparatus may be interlinked with one or more other terminal apparatuses.

Herein, a connection between two applications may be referred to as an ‘interlink,’ but other terms such as ‘link,’ ‘mashup,’ etc., could be used equivalently. In addition, when two applications are interlinked and operate with each other, they may be referred to herein as ‘two applications combined as one application.’

According to embodiments of the present disclosure, interlinked applications may provide metadata two-ways (mutual sharing) or only one way. For example, one application may provide metadata, and the other application may only receive the metadata but not transmit any metadata.

Herein, the term ‘touch input’ refers to a touch gesture performed with respect to a touch display. In addition, ‘touch input’ may include a non-contact or contactless touch which does not come into contact with the display and is spaced a certain distance apart from the display (for example, floating or hovering). The touch input may include a touch & hold gesture, a tap gesture of touching and then releasing the touch, a double-tap gesture, a panning gesture, a flick gesture, a touch-drag gesture of touching and then moving in a certain direction, a pinch gesture, etc., but not limited thereto.

FIG. 2 is a block diagram illustrating configuration of software according to an embodiment of the present disclosure. More specifically, FIG. 2 shows software, including an Operating System (OS) 240, a kernel 230, middleware 220, applications 210, etc.

The OS 240 controls and manages overall operations of hardware. That is, the OS 240 is a hierarchy of routines that perform basic functions including hardware management, a memory, security, etc.

The kernel 230 serves as a path for transmitting various signals, such as a detected touch signal, to the middleware 220.

The middleware 220 includes various software modules for controlling the operations of a terminal apparatus. In FIG. 2, the middleware 220 includes an X11 module 220-1, an APP manager 220-2, a connection manager 220-3, a security module 220-4, a system manager 220-5, a multimedia framework 220-6, a main UI framework 220-7, a window manager 220-8, and a sub UI framework 220-9.

The X11 module 220-1 receives various event signals from diverse hardware provided in the terminal apparatus. Herein, an event may vary, ranging from an event where a user gesture is sensed, to an event where a system alarm occurs, or an event where a specific program is executed or terminated, etc.

The APP manager 220-2 manages an execution status of various applications 210. For example, in response to an application execution event being detected from the X11 module 220-1, the APP manager 220-2 calls and executes an application corresponding to the event.

The connection manager 220-3 supports wired or wireless network connection. The connection manager 220-3 may include various specific modules such as a module for a proprietary software suite, such as DNET, a Universal Plug And Play (UPnP) module, etc.

The security module 220-4 supports Certification, Permissions, Secure Storage, and the like with respect to the hardware.

The system manager 220-5 monitors a status of each component of the terminal apparatus 100 and provides other modules with the monitoring result. For example, when there is not enough battery power left, or when an error occurs, or a communication connection is cut, off, the system manager 220-5 may provide the main UI framework 220-7 or the sub UI framework 220-9 with the monitoring result to output an alarm message or an alarm sound.

The multimedia framework 220-6 reproduces multimedia contents stored in the terminal apparatus 100 or provided from an external source. The multimedia framework 220-6 may include a player module, a camcorder module, a sound processing module, etc. Accordingly, the multimedia framework 220-6 may reproduce various multimedia contents to perform an operation of generating and reproducing video and audio.

The main UI framework 220-7 provides various UIs to be displayed in a main area of the display, and the sub UI framework 220-9 provides various UIs to be displayed in a sub area of the display. The main UI framework 220-7 and the sub UI framework 220-9 may include an image composite module that configures various UI objects (or UI elements), a coordinate composite module that calculates a coordinate where a UI object is displayed, a rendering module that renders the configured UI element on the calculated coordinate, a two-dimensional (2D)/three-dimensional (3D) UI toolkit that provides a tool for configuring a 2D UI or 3D UI, etc.

The window manager 220-8 may detect input events, such as a touch event using a user's body or a pen. In response to such an event being detected, the window manager 220-8 transmits an event signal to the main UI framework 220-7 or the sub UI framework 220-9 so as to perform an operation corresponding to the event.

Other than the above, the middleware 220 may further include a writing module for drawing a line according to a drag trace in response to a user touch/drag on the screen and diverse program modules, such as an angle calculation module for calculating a pitch angle, a roll angle, a yaw angle, and the like based on a sensor value sensed by one or more sensors.

The application module 210 includes applications 210-1 to 210-n supporting various functions. For example, the application module 210 may include program modules for providing diverse services, such as a navigation program module, a game module, an E-book module, a calendar module, an alarm management module, etc. The applications may be installed by default or may be installed by a user. In response to a UI object being selected, the main CPU 194 may execute an application corresponding to the selected object by using the application module 210.

The software structure illustrated in FIG. 2 is only an example, and thus, the present disclosure not limited thereto. Accordingly, a part of the structure shown in FIG. 2 may be omitted or modified, or a new element may be added according to the type and/or purpose of the terminal apparatus.

FIGS. 3A and 3B are views showing interlinking operations of a plurality of applications according to embodiments of the present disclosure.

When metadata 305 is inputted into a first application 310A-1, a second application 310A-2 and a third application 310A-3 which are interlinked with each other and first application 310A-1 are also provided with the metadata 305. The metadata may be originally input based on a control command received from a user while the first application 310A-1 is in operation or may be provided from other terminal apparatuses.

For example, if the first application 310A-1 is a music reproduction application, the second application 310A-2 is a Social Network Service (SNS) application, the third application 310A-3 is a video streaming reproduction application, and the user inputs a reproduce command with respect to a particular sound source in the music reproduction application 310A-1, tag information (for example, a song title, a singer, an album title, etc.) in the sound source corresponding to the reproduce command may be used as metadata. In this case, the SNS application 310A-2 that received the metadata may retrieve and display SNS information corresponding to a singer of the sound source. In addition, the video streaming reproduction application 310A-3 may retrieve and display a music video corresponding to a title of the sound source.

Interlinking operations according to embodiments of the present disclosure may be performed in real time. For example, in response to a second sound source automatically being reproduced in the music reproduction application 310A-1 after the above-described first sound source is reproduced, metadata on the second sound source may be provided to the SNS application 310A-2 and the video streaming reproduction application 310A-3. Applications 310A-2 and 310A-3 may further update the display screen based on the metadata.

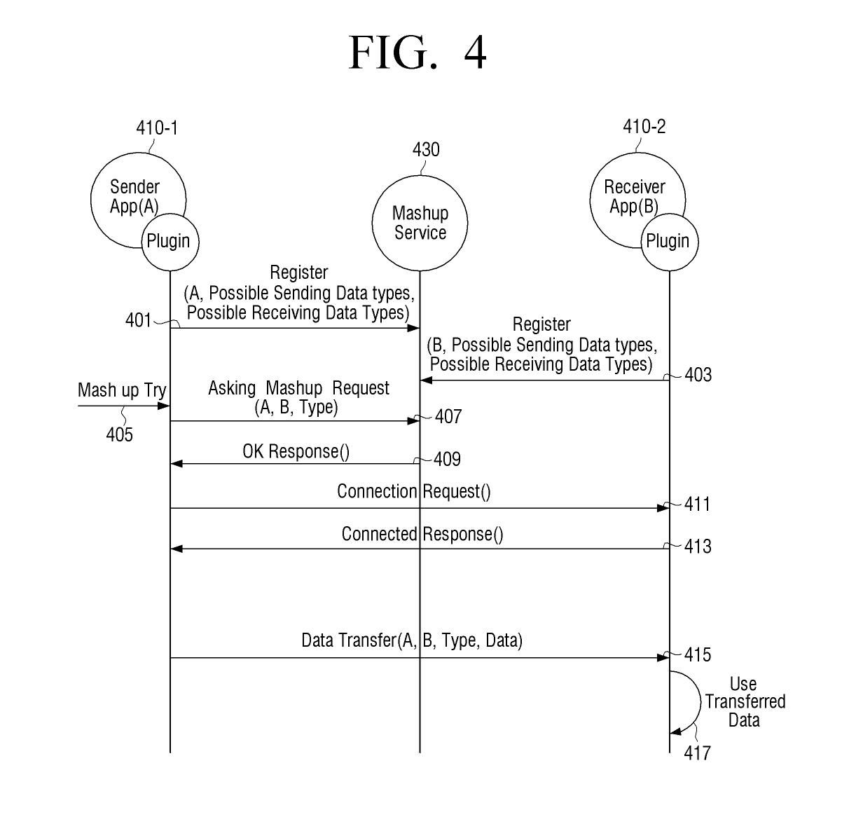

In the embodiment shown in FIG. 3A, the first application 310A-1 transmits the metadata to the second application 310A-2, and the second application 310A-2 transmits the received metadata to the third application 310A-3. However, depending on the implementation, the first application 310A-1 may transmit the metadata to both the second and third applications 310A-2 and 310A-3. In addition, thus far, the metadata has been described as being transmitted directly between applications, but depending on the implementation, the metadata may be relayed through one or more intermediate components/mediums (for example, middleware). In addition, depending on the embodiment, the above-described interlinking operations may be performed by an OS or an OS platform, such as, for example, Android, iOS, a windows OS, or Tizen, or by a particular application which operates in each operating system. This operation by an OS or OS platform is described in further detail with reference to FIG. 4 below.

In FIG. 3B, the terminal apparatus <Mobile> receives image content 311 and metadata <Metadata> relevant to the image content 311 from another terminal apparatus, in this case, <TV> 321. Herein, the image content 311 is broadcasting content, and the metadata on the broadcasting image comprises title 312, director 313, character 314, location 315, a sponsored property 316, etc.

In terminal apparatus <Mobile>, the first application 310B-1 is a TV reproduction application which is interlinked and operates with <TV> 321. Accordingly, the first application 310B-1 performs an operation of displaying a received broadcasting image. In addition, the first application 310B-1 may provide other interlinked applications 310B-2, 310B-3, 310B-4, 310B-5, 310B-6, 310B-7 with metadata <Metadata>.

Each of applications 310B-2, 310B-3, 310B-4, 310B-5, 310B-6, 310B-7 that receives/retrieves metadata performs respective functions and may display results on the screen.

For example, second application Internet Movie Database (IMDB)® 310B-2 retrieves the title 312, director 313, and character 313 from the received metadata and then displays information about the title 312, director 313, and character 313. The third application Map 310B-3 uses the location 315 out of the received metadata, and thus, provides information on the location 315. The fourth application Youtube® 310B-4 retrieves title 312 and character 314 and then recommends other images relevant to the content which is being reproduced or recommend other artworks or images relevant to the character, based on the retrieved title 312 and character 314.

The fifth application Twitter® 310B-5 retrieves title 312 and displays SNS entries (“tweets”) relevant to the content which is currently being reproduced, based on retrieved title 312. The sixth application Amazon 310B-6 retrieves metadata concerning sponsored property 316 related to the currently streaming content and displays purchase information concerning the sponsored property (which may be, for example, a DVD of the content). The seventh application Foursquare 310B-7 retrieves location 315 and provides content relevant to the location of the content which is currently being reproduced.

In FIG. 3B, seven applications operate by simultaneously receiving various portions of the metadata, but, depending on the implementation, less or more applications may operate simultaneously according to embodiments of the present disclosure. In addition, the metadata in FIG. 3B comprises five pieces of information 312, 313, 314, 315, and 316, but, depending on the implementation, the metadata may include only one piece of information or any number of pieces of information. Further still, the metadata of FIG. 3B is appropriate to the shared content, in this case, a movie or TV show; however, in other implementations, the metadata may include very different pieces of information, such as, for example, user account information, a control command, such as to turn on an apparatus or change a particular channel, or a URL address, user profile, user identification (ID) and password (PW), user address information, etc.

FIG. 4 is a view illustrating an interlinking operation between two applications according to an embodiment of the present disclosure.

In steps 401 and 403 of FIG. 4, first application Sender App(A) 410-1 and second application Receiver App(B) 410-2, respectively, register types of receivable and transmittable metadata with a relay service, i.e., Mashup Service 430. Herein, “relay service” refers to a service that determines how two or more applications are interlinked and at least partially controls the applications. In embodiments according to the present disclosure, the relay service may be an element in the middleware illustrated in FIG. 2. The metadata may be transmitted in a wide variety of formats, such as, for example, a file (media file, document file, etc.), Hash Tags, Stream data, Action Link (commander), MIME type, etc.

Subsequently, in response to a touch gesture by the user for linking the first application Sender App(A) 410-1 with the second application Receiver App(B) 410-2 in step 405, the first application 410-1 requests linking with second application 410-2 to the relay service 430 in step 407.

Upon receiving the request, relay service 430 determines whether the first and second applications 410-10 and 410-2 may be interlinked based on, inter alia, pre-registered information and, in step 409, provides the first application Sender App(A) 410-1 with the results of the determination. If the two applications may not share such metadata, the relay service 430 notifies the first application Sender App(A) that an interlinking operation is unavailable.

If the first application Sender App(A) 410-1 is notified that the interlinking operation is available in step 409, the first application Sender App(A) 410-1 notifies the second application Receiver App(B) 410-2 that the two applications are interlinked in step 411 (via ConnectionRequest( ), and the second application Receiver App(B) 410-2 transmits a response to the notification to the first application Sender App(A) 410-1 in step 413 (via ConnectedResponse( ).

Subsequently, in response to, for example, the metadata being received from the user or from an external apparatus, the first application Sender App(A) 410-1 provides the second application Receiver App(B) 410-2 with the received metadata in step 415. The first application Sender App(A) 410-1 may provide the second application Receiver App(B) 410-2 with only the types of metadata that may be used in the second application Receiver App(B) 410-2 or with all types of metadata. In this embodiment, the second application Receiver App(B) 410-2 that received the metadata may use it to perform a search and then display a search result in step 417.

When an application is incapable of transmitting metadata to another application, a Plugin or Plug-in, as illustrated with each of first application Sender App(A) 410-1 and second application Receiver App(B) 410-2 in FIG. 4, may perform the operation of transmitting/receiving metadata to/from other terminal apparatuses and/or applications. Herein, a Plug-in refers to a bridge module in which a defined protocol, such as, a transmitter, a receiver, a data type, an action, etc., is realized for communication between one application (or band) and another application.

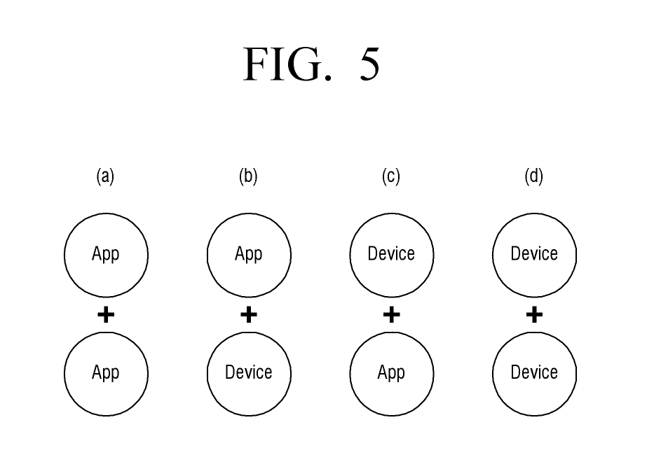

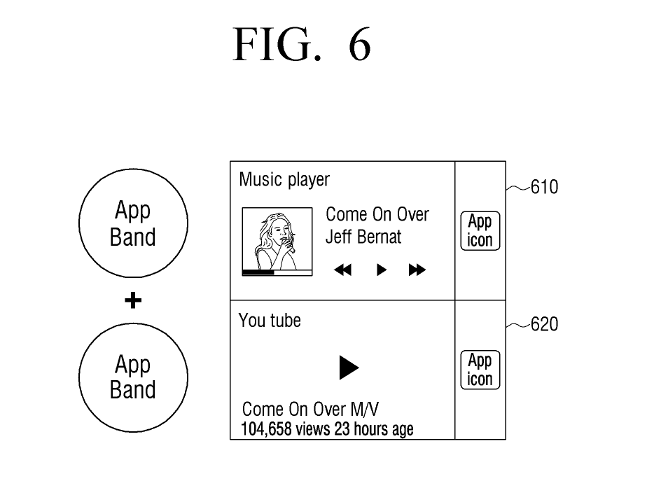

FIG. 5 is a representation of four types of interlinking operations which may be performed according to embodiments of the present disclosure. FIGS. 6 to 10 are views of screen displays showing various examples of interlinking operations according to embodiments of the present disclosure.

FIG. 5 shows four types of interlinking operation which may be performed according to embodiments of the present invention: (a) interlinking between applications (App+App), (b) interlinking between an application and another terminal apparatus (App+Device), (c) interlinking between a terminal apparatus and an application (Device+App), and (d) interlinking between two other terminal apparatuses (Device+Device).

FIG. 6 illustrates an example of interlinking between applications (App+App).

In FIG. 6, application 610 is a music reproduction application, and application 620 a streaming video reproduction application. In this example, the first and second applications 610 and 620 are interlinked while the first application 610 is reproducing stored sound tracks sequentially. The second application 620 retrieves and displays a music video corresponding to the song titles of each of the reproduced sound tracks.

If the user inputs a reproduce command with respect to the music video retrieved by the second application 620, the second application 620 transmits a music reproduction stop command to the first application 610 as metadata. Accordingly, the first application 610 stops the music reproduction. If a second music video is reproduced in the second application 620 after the first music video is reproduced, the second application 620 may provide the first application 610 with metadata on the second music video.

Recent terminal apparatuses operate with diverse peripheral devices. For example, users can control a TV by using a smart phone and may use a smart watch to provide a smart phone with information on a phone call or message transmission.

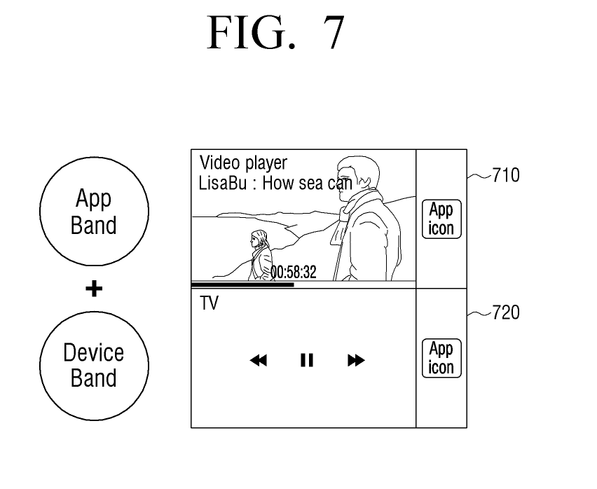

FIG. 7 illustrates an example of interlinking between an application and another terminal apparatus (App+Device).

In FIG. 7, the first application 710 is a video application, and the second application 720 is a mirroring application. More specifically, the second application 720 controls the operation of a TV, i.e., the other terminal apparatus, or provides the other terminal apparatus with content stored in the terminal apparatus, in a mirroring method so that the content is displayed in the other terminal apparatus.

When the first application 710 and the second application 720 are interlinked, the first application 710 may transmit content and reproduce command metadata on the content to the second application 720. The second application 720 may transmit the received content to another terminal apparatus, such as a TV, in a streaming method. In addition, the second application 720 may display a UI for receiving control commands of the content, such as a reproduce control command, based on the received metadata.

For example, if the second application 720 receives a reproduction stop command, the second application 720 stops streaming a screen to the TV (more specifically, maintain a streaming operation and stop changing the screen to a new screen) according to the received control command and transmit the received reproduction stop command to the first application 710 as metadata.

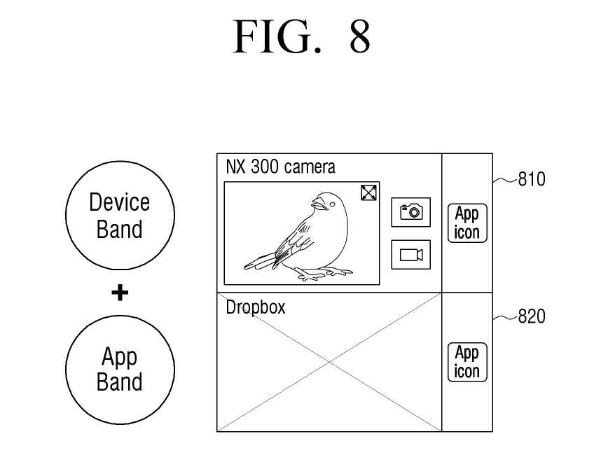

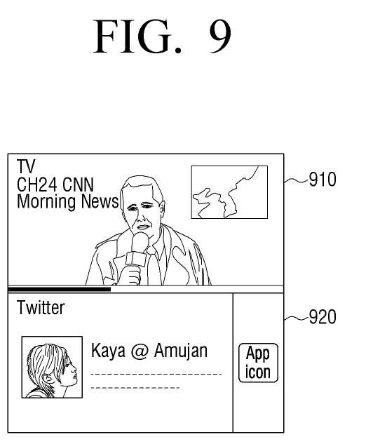

In FIG. 7, an application in one terminal apparatus provides another terminal apparatus with metadata; in FIGS. 8 and 9, metadata from another terminal apparatus is provided to an application in the terminal apparatus.

FIGS. 8 and 9 are examples illustrating interlinking operations between another terminal apparatus and an application.

In FIG. 8, a first application (“NX 300 camera”) 810 and a second application (“Dropbox”®) 820 are interlinked and operate with each other. Herein, the first application 810 is a camera application which is interlinked with and operates a camera, that is, the other terminal apparatus. The first application 810 controls photographing operations of the camera and/or reproduction of content stored in the camera. The second application 820 stores and/or reads content in/from a cloud server corresponding to a user account.

While the camera is connected to the terminal apparatus with the first application 810, the terminal apparatus may operate the camera automatically through the first application 810, and the second application 820 which is interlinked with the first application 810 may also operate automatically.

For example, the first application 810 may read user information from the camera as metadata and provide the second application 820 with account information corresponding to the user information. The second application 820 uses the received account information to access the cloud server according to the provided account information and displays information stored in the cloud server account.

As another example, when a photographing operation performed in the camera generates picture data, the first application 810 may acquire the generated picture data from the camera and transmit the acquired picture data to the second application 820, which uploads the received picture data to the cloud server account. In some embodiments, picture data which is not uploaded to the cloud server user account by the user may be automatically stored in the cloud server through the first application 810 and the second application 820 without any user input. For example, the second application 820 may acquire picture update information from the cloud server account and provide the first application 810 with the acquired picture update information. Similarly, the first application 810 may transmit any picture data photographed after a predetermined point of time to the second application 820, which uploads the received picture date to the cloud server. These two operations may comprise synchronization between the camera and the cloud server.

In FIG. 9, the first application (“Morning News”) 910 is a TV broadcasting application which acquires image data and metadata thereof from a TV, that is, the other terminal apparatus and the second application (“Twitter”) 920 is an SNS application. In response to the image data being received from the other terminal apparatus (the TV), the first application 910 displays the received image data and provides the second application 920 with metadata relevant to the image data. The second application 920 that received the metadata may find and display a SNS article regarding the broadcasting program.

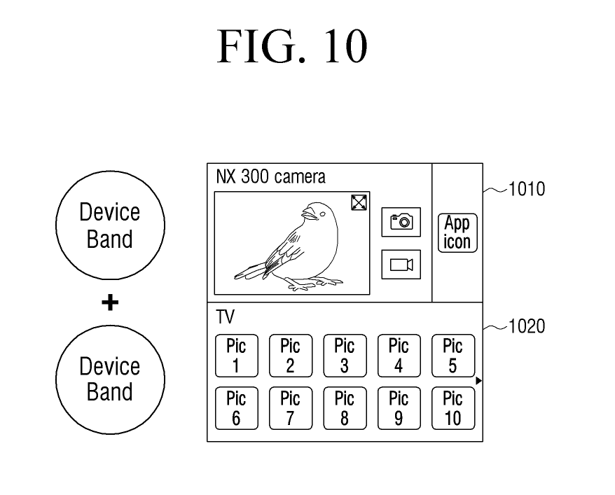

In FIGS. 8 and 9, only one application is interlinked with the other terminal apparatus, but in FIG. 10 two applications are interlinked with two other terminal apparatuses.

FIG. 10 is an example illustrating interlinking between two other terminal apparatuses.

In FIG. 10, the first application (“NX 300 camera”) 1010 is a camera application which is interlinked with and operates a camera, that is, a first other terminal apparatus, and may control photographing operations of the camera and/or reproduction of content stored in the camera. The second application (“TV”) 1020 is an application which controls an operation of a TV, that is, a second other terminal apparatus, or provides the second other terminal apparatus with content stored in its terminal apparatus in a mirroring method so that the content is reproduced on the screen of the second other terminal apparatus. When picture data is generated by the camera, the first application 1010 acquires the generated picture data from the camera and transmits the acquired picture data to the second application 1020, which transmits the picture data to the TV, that is, the second other terminal apparatus so that the picture data is displayed on the screen of the TV.

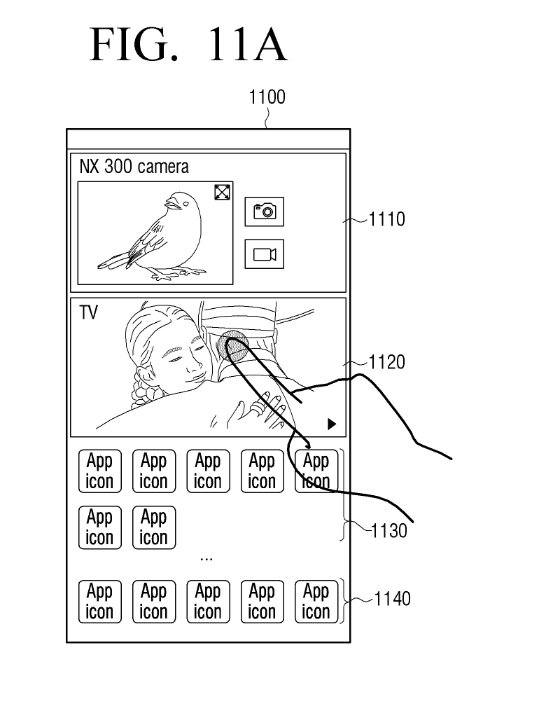

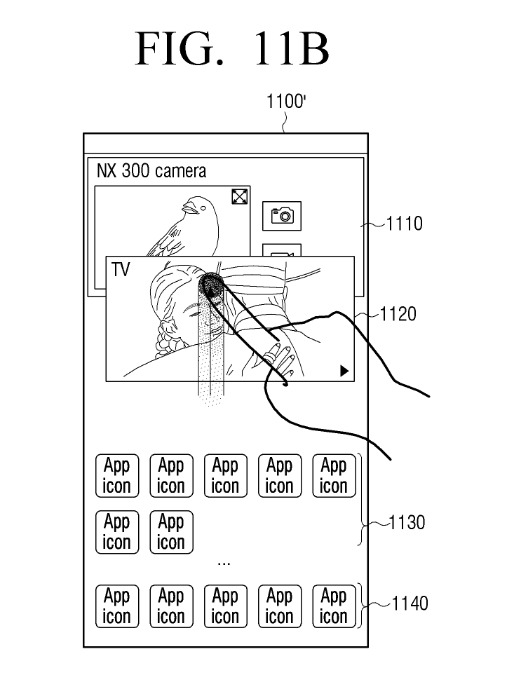

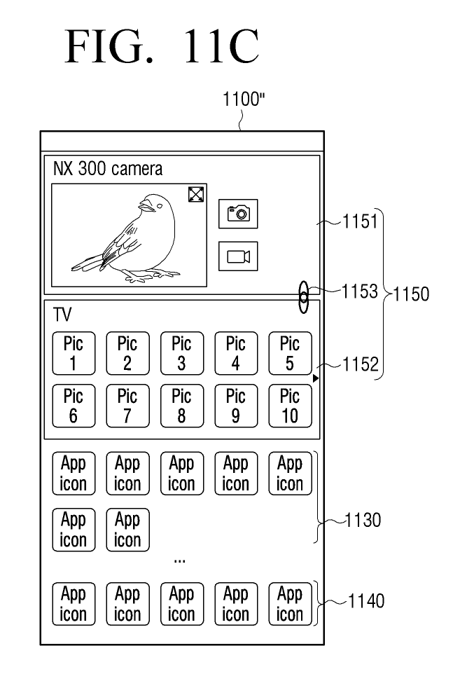

FIGS. 11A to 11C are views of consecutive screen displays when performing a method for setting interlinking according to a first embodiment of the present disclosure.

In FIG. 11A, a UI window 1100 includes execution windows 1110 and 1120, an application display area 1130, and a fixed application display area 1140.

Execution windows 1110 and 1120 correspond to first and second applications selected by a user. First and second applications may also be referred to by reference numerals 1110 and 1120, respectively, herein. In other embodiments, the execution windows may be widgets.

The application display area 1130 displays icons of some of the applications which are installed in the terminal apparatus. Because terminal apparatus has a screen with limited size, application display area 1130 cannot display the icons of all of the some applications installed in the terminal apparatus simultaneously. Accordingly, in some embodiments, the user can scroll the application display area 1130 to the left or to the right to display the icons of the other applications.

The fixed application display area 1140 displays the icons of applications which remain in view and do not change, by contrast to the icons displayed in the application display area 1130 which may be changed by, for example, a screen scrolling operation. In some embodiments, when the user performs a screen scrolling operation in the fixed application display area 1140, the icons in the fixed application display area 1140 may be scrolled through while the screen of the application display area 1130 remains fixed.

In FIG. 11A, the user wishes to interlink the first application (“NX 300 camera”) 1110 and the second application (“TV”) 1120. Accordingly, the finger on the hand of the user is shown selecting execution window 1120 of the second application in the UI window 1100 of FIG. 11A in order to drag and drop execution window 1120 on execution window 1110 of the first application, as illustrated in FIGS. 11B and 11C.

Accordingly, UI window 1100′ in FIG. 11B shows the user's finger moving/dragging second application window 1120 over on top of first application window 1110.

FIG. 11C shows the result of the dragging-and-dropping operations shown in FIGS. 11A and 11B. Specifically, UI window 1110″ in FIG. 11C includes a new screen area 1150 of the two interlinked applications, application display area 1130, and fixed application display area 1140. The interlinked applications display area 1150 includes execution windows 1151 and 1152 of the first and second applications, respectively, visually linked together by an interlink indicator/icon/symbol/sign 1153. In this embodiment, interlink indicator/icon/symbol/sign 1153 is a graphic symbol resembling a chain link. Except for interlink indicator/icon/symbol/sign 1153, first application execution window 1151 is the same as first application execution window 1110 of FIGS. 11A and 11B.

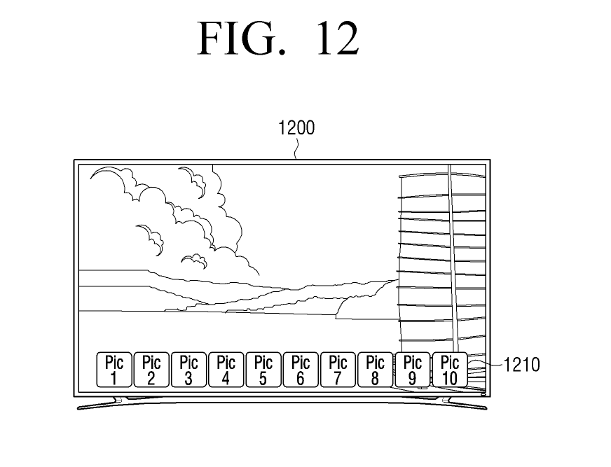

Second application execution window 1152 displays a sub UI of the second application, rather than, for example, the main UI 1120 shown in FIGS. 11A and 11B. Specifically, the second application execution window 1152 of FIG. 11C displays a plurality of icons corresponding to a selection of picture content stored in the camera, that is, the first other terminal apparatus. The second other terminal apparatus, that is, the TV, displays a screen corresponding to the second application execution window 1152, an example of which is illustrated in FIG. 12.

FIG. 12 is an example of a User Interface (UI) window displayed on a TV, i.e., other terminal apparatus, which is interlinked with the second application (execution window 1152 in FIG. 11C), according to an embodiment of the present disclosure.

In FIG. 12, a UI window 1200 is displayed on the screen of the second other terminal apparatus, which, in this case, is a TV. UI window 1200 is provided by the terminal apparatus with the screens displayed in FIGS. 11A-11C. UI window 1200 displays one piece of content, a photo, stored in the camera, that is, the first other terminal apparatus, and thumbnails 1210 of the other content stored in the camera on one side (in this case, the bottom side). In the example illustrated by FIGS. 11A-11C and 12, the interlinked second application execution window 1152 in FIG. 11C and the UI window 1200 in FIG. 12 do not have the same screen, but in other implementations, the same screen may be displayed (or “mirrored”) in both the second other terminal apparatus and the terminal apparatus running the second application.

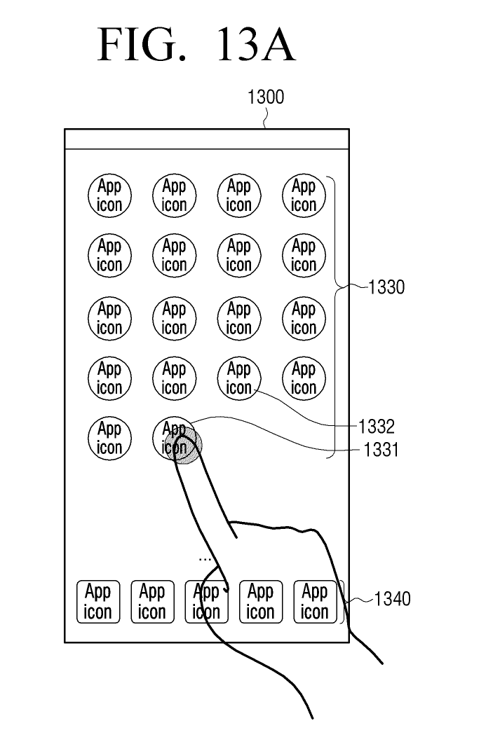

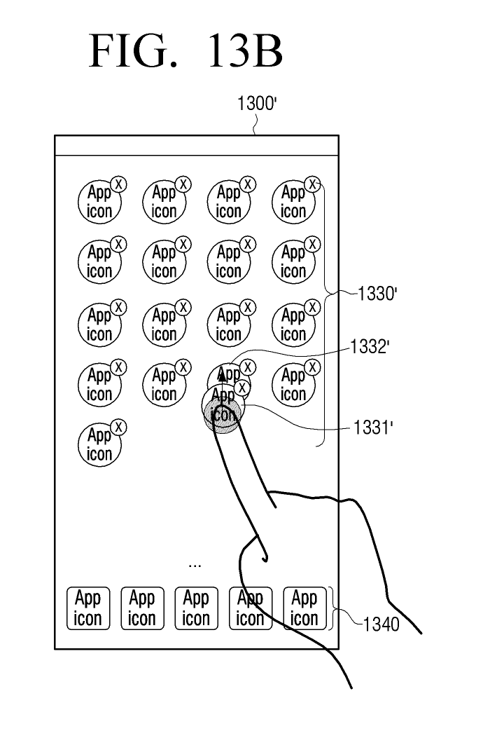

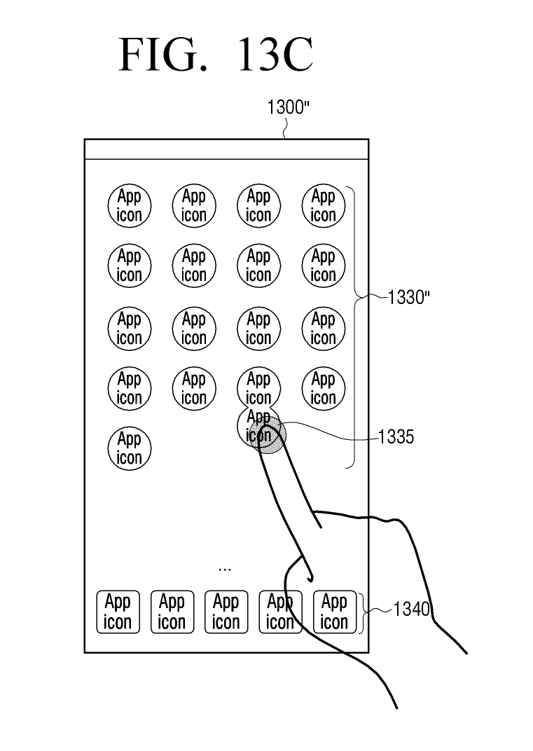

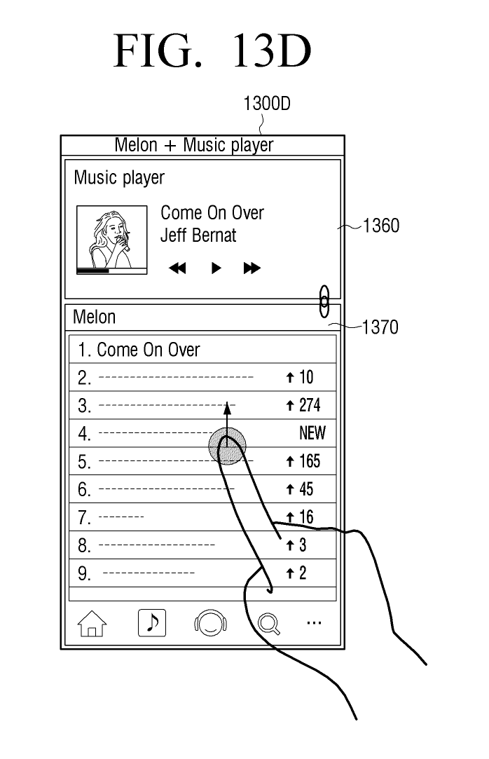

FIGS. 13A to 13D are views of consecutive screen displays when performing a method for setting interlinking according to a second embodiment of the present disclosure.

In FIG. 13A, UI window 1300 includes application display area 1330 and fixed application display area 1340. Application display area 1330 is substantially similar in function to application display area 1130 in FIGS. 11A-11C and fixed application area 1340 is substantially similar to fixed application display area 1140 in FIGS. 11A-11C and so detailed descriptions thereof are omitted herein.

In FIG. 13A, the user wishes to interlink a first application, corresponding to icon 1331, and a second application, corresponding to icon 1332. In this embodiment, the user selects icon 1331 of the first application and holds it for a predetermined period of time. In this embodiment, when an icon is selected and held for over the predetermined period of time, the terminal apparatus enters a mode or environment where interlinking between applications is available for the user to set. In this mode/environment, an icon corresponding to an application may be moved/dragged by a user touch manipulation and then dropped on an icon of another application in order to interlink the two applications. Accordingly, the user's finger in FIG. 13A is shown selecting the icon 1331 corresponding to the first application as a start to the process of setting an interlinking.

In FIG. 13B, the terminal apparatus has switched to the mode/environment for setting interlinking and the user's finger drags icon 1331′ over to icon 1332′ on UI window 1300′. In FIG. 13C, icon 1331′ and icon 1332′ have merged to form new icon 1335, as shown in UI window 1300″.

FIG. 13D is a view illustrating an example of a UI window which is displayed on the screen in response to merged icon 1335 of FIG. 13C being selected.

In FIG. 13D, UI window 1300D includes first application execution window 1360 and second application execution window 1370. In this embodiment, the first application is an application (“Music player”) for reproducing a sound file or track stored in the terminal apparatus, and the second application is an application (“Melon”) for reproducing a sound file or track stored on a server, that is, a streaming music reproduction application.

As shown in FIG. 13D, first application execution window 1360 displays information on the sound file, track, or source which is currently being reproduced and control commands, such as a music reproduction control command. The second application execution window 1370 receives metadata, such as a title of the sound source which is currently being reproduced in the first application, and displays information on the title. In the illustrated example, the order of the sound tracks to be reproduced is displayed in second application execution window 1370, but in other implementations, other information, such as information on an album including the currently-playing sound source, information on the singer of the currently-playing sound source which is currently being reproduced, etc., may be displayed.

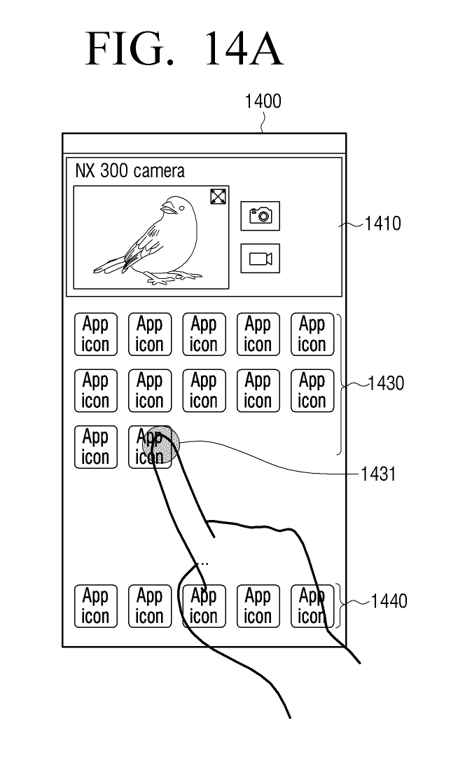

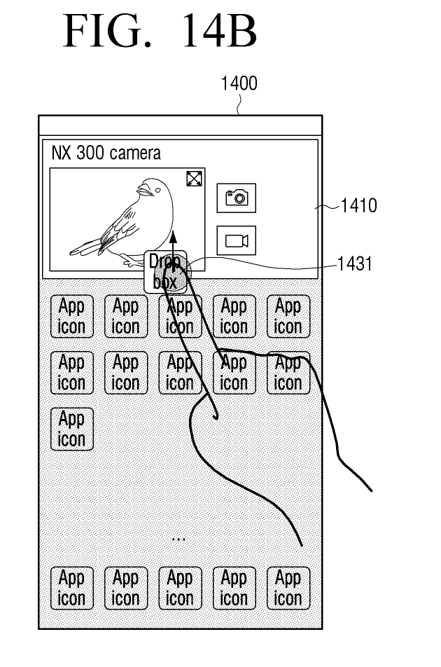

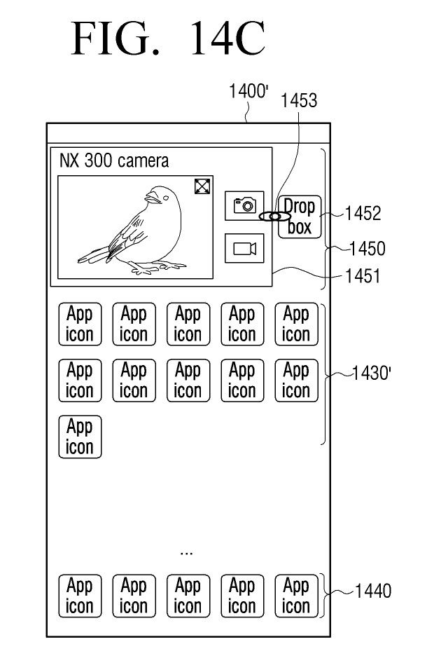

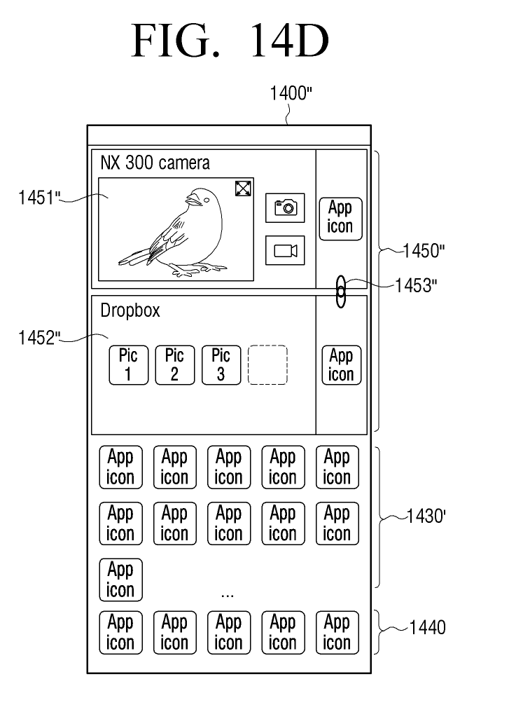

FIGS. 14A to 14D are views of consecutive screen displays when performing a method for setting interlinking according to a third embodiment of the present disclosure.

In FIG. 14A, UI window 1400 includes a first application execution window 1410, application display area 1430, and fixed application display area 1440. In other embodiments, the execution windows may take a variety of forms, including, but not limited to, one or more widget windows. The application display area 1430 and the fixed application display area 1440 are substantially the same as application display area 1130 and fixed application display area 1140 in FIGS. 11A-11C, and thus, their detailed description is omitted herein.

In FIG. 14A, the user wishes to interlink the first application execution window 1410 and icon 1431 corresponding to the second application in UI window 1400. In this embodiment, the user selects icon 1431 as illustrated in FIG. 14A and drags over and then drops the icon 1431 on the first application execution window 1410, as illustrated in FIG. 14B.

In FIG. 14C, UI window 1400″ includes interlinked applications area 1450, application display area 1430′, and fixed application display area 1440. The interlinked applications area 1450 includes first application execution window 1451, an area in which icon 1452 of the second application is displayed, and an interlink indicator/icon/symbol/sign 1453, which, in this case, is a link graphic. The first application execution window 1451 is smaller, but otherwise substantially the same as the first application execution window 1410 of FIGS. 14A and 14B, and thus, a detailed description thereof is omitted herein.

As indicated above, first application execution window 1451 in FIG. 14D is smaller than first application execution window 1410 in FIGS. 14A-14B, and the open area created by the shrinking of window 1410 is used for displaying icon 1452 of the second application, which the user moved from the application display area 1430. As a consequence, application display area 1430′ no longer shows that icon. The interlinking is indicated by the interlink indicator/icon/symbol/sign 1453.

In FIG. 14D, a UI object of the second application has been selected by the user, and thus is changed from icon 1452 as shown in FIG. 14C to an execution window (or a widget window) which is displayed concurrently with its interlinked applications as illustrated in FIG. 14D. As another example of when such a switch may occur, when an output result of metadata needs to be displayed in a UI screen of the second application, UI window 1400″ illustrated in FIG. 14D may be displayed. By contrast, when the output result of the metadata does not need to be displayed in the UI screen of the second application (for example, when the second application stores metadata of the first application), UI window 1400′ illustrated in FIG. 14C may be displayed.

In FIG. 14D, interlinked applications area 1450″ includes first application execution window 1451″, second application execution window 1452″ (which replaced icon 1452 in FIG. 14C), and an interlink indicator/icon/symbol/sign 1453″, which again is a link graphic.

FIGS. 15A and 15B are views of screen displays when performing a method for setting interlinking according to a fourth embodiment of the present disclosure.

In FIG. 15A, a UI object 1500 includes a UI object area 1503 and interlink area 1505. The UI object area 1503 displays an execution window or, for example, a widget window, of a selected application. In the example illustrated in FIG. 15A, a widget (or tile) of an application which is interlinked and operates with a TV is displayed in UI object area 1503. The interlink area 1505 is an area for receiving a user command to perform interlinking between any applications interlinked with the application displayed in the UI object area 1503 and the application displayed in the UI object area 1500. In response to such a user command being received, the UI windows corresponding to the interlinked applications are displayed with UI window 1500 as illustrated in FIG. 15B.

In FIG. 15A, UI object/window 1500 is displayed with a plurality of UI windows corresponding to interlinked applications. In this case, UI window 1500 of FIG. 15A is displayed on top, below which UI windows 1510, 1520, and 1530 of other applications which are interlinked and operate with the application displayed in UI window 1500. In order to do this, the terminal apparatus may, for example, search for other applications which are interlinked with the application corresponding to UI window 1500 when the interlink user command is received from the interlink area 1505 as illustrated in FIG. 15A.

In the example illustrated in FIG. 15B, an Internet search application 1510, an SNS application 1520, and a streaming image reproduction application 1530 are the results of such a search and are thus displayed as applications which may be operated with the application in UI window 1500 (i.e., an application operating a TV terminal), but in other implementations, needless to say, the search may result in other applications.

In other embodiments of the present disclosure, a link cancel command and/or a UI object/window for managing an interlinked application may also be displayed. If there are too many interlinked application to show on the screen, some of the interlinked applications may be displayed, and a “See more” button may be shown at the bottom of the screen. In other embodiments, a recommended list of applications for interlinking may be displayed.

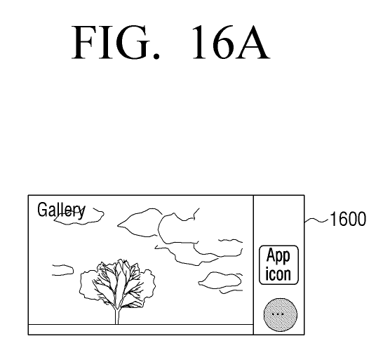

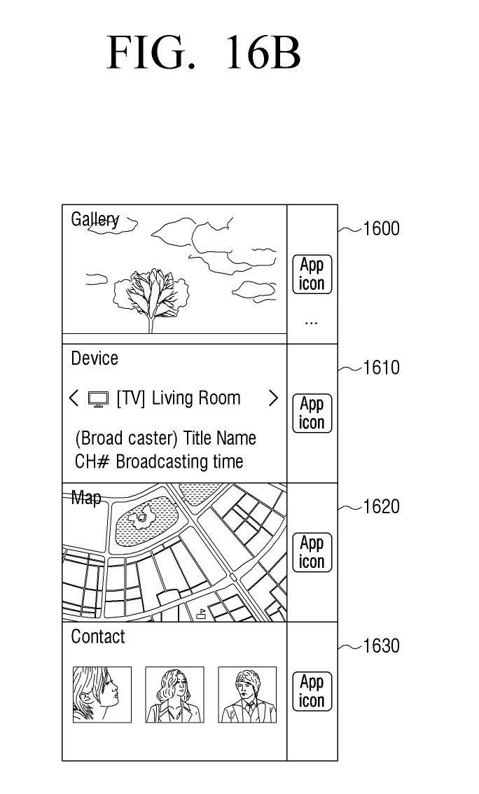

FIGS. 16A and 16B are also views of screen displays when performing a method for setting interlinking according to the fourth embodiment of the present disclosure. To be specific, only the type of the first application of FIGS. 16A-16B is different from FIGS. 15A-15B, and otherwise the operations are the same.

In FIG. 16A, UI window 1600 comprises an execution window of an application (“Gallery”) for displaying picture content which is stored in the terminal apparatus. In response to an interlink command being input, applications interlinked with the picture application are displayed in FIG. 16B. More specifically, FIG. 16B shows UI window/object 1610 corresponding to an interlinked TV application for displaying a picture content in a TV, UI window/object 1620 corresponding to a map application for displaying location information based on Global Positioning System (GPS) information of a picture, and UI window/object 1630 corresponding to a phone call/contacts application for enabling a user to make a phone call, etc.

In various embodiments of the present disclosure, the picture content may be stored with metadata, such as information on a theme/subject of the picture content, photographer information, subject information, etc. Accordingly, the picture application may provide metadata such as information on the subject to the phone call/contact application, the phone call/contact application may search for any relevant contacts based on the received metadata, and then, if one or more contacts are found, the phone call/contact application may display icons for making a phone call to each of the one or more found contacts.

The plurality of interlinked applications may return to an original state thereof by user setting. For example, in the screens of FIGS. 11C, 14C, and 14D, interlinking between applications may be cancelled by a user input gesture, such as touching the interlink indicators/icons/symbols/signs 1153, 1453, and 1453″, respectively. In addition, in the screen of FIG. 13C, the interlinking between applications may be cancelled by a user input gesture, such as pressing interlinked/combined icon 1335 for a predetermined time, resulting in icon 1335 dividing back into two icons 1331 and 1332.

FIGS. 17A and 17B are examples of visual representations of a preview operation according to an embodiment of the present disclosure.

In FIG. 17A, the user selects a second UI object (“B: RECEPTION”) 1720 and then moves and places the second UI object 1720 on a first UI object (“A: TRANSMISSION”) 1710 in a touch and drag operation so that the second UI object 1720 is linked with the first UI object 1710. In this embodiment, while two UI objects are superimposed until the two UI objects are detached or one UI object is placed on the other UI object in response to a user touch being released, a preview screen of the second UI object 1720 is displayed for the user. For example, in response to the second UI object 2720 being changed due to interlinking while a first UI object 2710 remains without change, the display 120 may change and display the second UI object to a preview screen including preview of the two applications corresponding to the two interlinked UI objects.

In FIG. 17B, the user selects a fourth UI object (“B: TRANSMISSION”) 1740 and then moves and places the fourth UI object 1740 on third UI object (“A: RECEPTION”) 1730 by a drag and drop method so that the fourth UI object 1740 is linked with the third UI object 1730. In this embodiments, while two UI objects are superimposed until the two UI objects are detached or one UI object is placed on the other UI object, a preview screen of the third UI object 1730 is displayed. For example, in response to the third UI object being changed due to interlinking while the fourth UI object 2740 remains without change, the display 120 may change and display the third UI object to a preview screen.

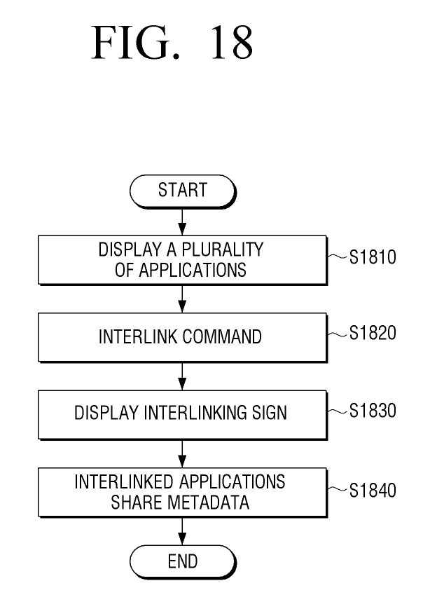

FIG. 18 is a flowchart of a method for controlling a terminal apparatus according to an embodiment of the present disclosure.

In step S1810, UI objects of each of a plurality of stored applications are displayed. Herein, a UI object may be, for example, an icon, a widget, or an execution window of an application. In step S1820, a user interlink command along with the user's selection of applications to be interlinked among the plurality of displayed applications is received, and the selected applications are interlinked. In step S1830, an indicator/icon/symbol/sign indicating that the applications corresponding to the UI objects are interlinked is displayed.

After the applications have been interlinked in steps S1810 to S1830, when metadata with respect to one application is being inputted and/or otherwise received/retrieved, it is provided to the other application which is interlinked with the one application in step S1840. Although the method of FIG. 18 may be executed in a terminal apparatus having the structure shown in FIG. 1, the present disclosure is not limited thereto, and a variety of other structures, configurations, architectures, etc., may be used in other embodiments.

In methods for controlling a terminal apparatus according to embodiments of the present disclosure, metadata input into and/or otherwise received by one interlinked application is provided to the other interlinked application without any user manipulation, and thus, a user is able to, for example, access diverse information easily and without effort. In addition, a terminal apparatus according to embodiments of the present disclosure allows a user to interlink a plurality of applications, one or more applications with another terminal apparatus, or two other terminal apparatuses easily and intuitionally by simple touch manipulation.

Any methods described herein may be realized as a program, set of instructions, etc. which may be executed in a computer. The program may be stored in and retrieved from a non-transitory computer readable medium.

The non-transitory computer readable medium may be any medium which stores data permanently, semi-permanently, or in any otherwise non-transitory manner, and is readable by a computing apparatus of any form/size. For example, the above-described methods, processes, applications, and/or programs may be stored in and readable from non-transitory computer readable mediums such as a Compact Disc (CD), Digital Versatile Disk (DVD), hard disk, Blu-ray disk, Universal Serial Bus (USB) memory, memory card, Read-Only Memory (ROM), etc.

Accordingly, any such programs may be installed in any type of device, such as a terminal apparatus, in which a plurality of applications can be installed and can be interlinked and operate with each other.

While specific embodiments have been particularly shown and described above, it will be understood by those of ordinary skill in the art that various changes, modifications, additions, subtractions, and/or other alterations may be made without departing from the spirit and scope of the present invention as defined by the following claims. The foregoing embodiments are provided for the purpose of description/illustration only and are not to be construed as limiting the present disclosure in any manner.

What is claimed is:

1. A terminal apparatus comprising:
storage capable of storing a plurality of applications, some of which may be interlinked;
a display capable of displaying a User Interface (UI) screen of a first application among the plurality of stored applications; and
a controller which, if metadata is input into the first application corresponding to the displayed UI screen, provides a second application which is interlinked with the first application with at least some of the metadata input into the first application.

2. The terminal apparatus in claim 1, wherein the display is further capable of simultaneously displaying a first screen for displaying an execution result of the first application with respect to the input metadata and a second screen for displaying an execution result of the second application with respect to the input metadata.

3. The terminal apparatus in claim 1, wherein the display is further capable of simultaneously displaying a first UI object of the first application and a second UI object of the interlinked second application.

4. The terminal apparatus in claim 3, wherein the display is further capable of displaying a sign indicating that the first UI object and the second UI object are interlinked.

5. The terminal apparatus in claim 3, wherein the UI object is at least one of an icon, a widget, and an execution window of its corresponding application.

6. The terminal apparatus in claim 1, wherein the controller provides the second application with content displayed in the first application.

7. The terminal apparatus in claim 1, wherein the second application is an application which is interlinked with another terminal apparatus, and wherein the terminal apparatus further comprises:
a communication interface capable of providing the other terminal apparatus with at least one of metadata and content provided by the first application.

8. The terminal apparatus in claim 1, where the first application is an application which is interlinked with another terminal apparatus, and wherein the terminal apparatus further comprises:
a communication interface capable of receiving at least one of metadata and a content from the other terminal apparatus.

9. The terminal apparatus in claim 1, further comprising:
a manipulation input unit capable of receiving control commands from a user, including a control command with respect to the first application,
wherein the controller is capable of updating metadata of the first application according to an input control command and providing the second application with the updated metadata.

10. The terminal apparatus in claim 1, further comprising:
a manipulation input unit capable of receiving control commands from a user, including a control command with respect to the second application,
wherein the controller is capable of generating metadata for the second application according to an input control command and providing the first application with the updated metadata.

11. The terminal apparatus in claim 1, wherein the metadata comprises at least one of a content attribute, account information, location information, Uniform Resource Locator (URL) information, and a control command.

12. The terminal apparatus in claim 1, wherein the controller searches for applications which use metadata corresponding to metadata inputted into the first application and the controller is capable of linking any applications found in the search with the first application.

13. The terminal apparatus in claim 12, wherein the display displays the found applications, and wherein the terminal apparatus further comprises:
a manipulation input unit capable of receiving a user selection of at least one of the displayed applications,
wherein the controller links the selected application with the first application.

14. The terminal apparatus in claim 12, wherein, in response to an icon displayed on one side of the UI screen of the first application being selected, the controller searches for an application which uses metadata corresponding to metadata inputted into the first application.

15. The terminal apparatus in claim 1, wherein the display is capable of displaying UI objects, each of which corresponds to one of the plurality of applications, and
wherein, in response to at least one first displayed UI object being placed on a second displayed UI object, the controller interlinks the applications corresponding to the first and second UI objects.

16. The terminal apparatus in claim 1, wherein the display is capable of displaying UI objects, each of which corresponds to one of the plurality of applications, and
wherein, in response to at least one first displayed UI object being superimposed on a second displayed UI object, at least one of the first UI object and the second UI object displays a preview screen of what is displayed when the two applications corresponding to the first and second UI objects are interlinked.

17. A terminal apparatus comprising:
storage capable of storing a plurality of applications;
a display capable of displaying User Interface (UI) objects, each of which corresponds to one of the plurality of stored applications; and
a controller which, in response to at least one first displayed UI object being placed on a second displayed UI object, interlinks the two applications corresponding to the first and second UI objects.

18. A method for controlling a terminal apparatus, comprising:
displaying a User Interface (UI) screen of a first application from among a plurality of applications stored on the terminal apparatus; and
if metadata is input into the first application corresponding to the displayed UI screen, providing a second application which is interlinked with the first application with at least some of the metadata inputted into the first application.

19. A method for controlling a terminal apparatus, comprising:
displaying User Interface (UI) objects. each of which corresponds to one of a plurality of applications stored on the terminal apparatus; and
when a control command to place at least one first displayed UI object on a second displayed UI object is received, interlinking the two applications corresponding to the first and second UI objects.

20. A non-transitory computer readable medium having a program for executing a method for controlling a terminal apparatus, the method comprising:
displaying a User Interface (UI) screen of a first application from among a plurality of applications stored on the terminal apparatus; and
if metadata is input into the first application corresponding to the displayed UI screen, providing a second application which is interlinked with the first application with at least some of the metadata inputted into the first application.
